(19) United States
(12) Patent Application Publication
(10) Pub. No.: US 2020/0175441 A1
(43) Pub. Date: Jun. 4, 2020

(54) METHOD AND DEVICE FOR PLANNING COMPANY ASSET OPERATIONS

(71) Applicant: OPTIMAL MANAGEMENT LIMITED LIABILITY COMPANY [RU/RU], Moscow (RU)

(72) Inventor: Artem Andreevich SUKHOBOKOV, Moscow (RU)

(73) Assignee: OPTIMAL MANAGEMENT LIMITED LIABILITY COMPANY [RU/RU], Moscow (RU)

(21) Appl. No.: 16/625,297

(22) PCT Filed: Jun. 21, 2017
(86) PCT No.: PCT/RU2017/000440

§ 371 Date: Dec. 20, 2019

(51) Int. Cl. G06Q 10/06; G06Q 40/06

(52) U.S. Cl. CPC G06Q 10/0637; G06Q 10/06313; G06Q 40/06; G06Q 10/067

(57) ABSTRACT

Proposed is an algorithm for long-term optimal planning of asset operations for companies having large stocks of assets, which is conceptually similar to the MRP II algorithm for material requirements planning. The present algorithm envisages generating scenarios of the long-term development of a company, and sorting said scenarios for the purpose of identifying a scenario which provides the maximum net discounted profit for an entire period. The scenarios determine the completion dates of projects relating to the acquisition and building of new assets and the rebuilding of existing assets. Each scenario is broken up into yearly intervals, for which optimal internal supply chain plans are calculated, and an evaluation of the implementability of said supply chains on the basis of available assets is conducted. In essence, the proposed algorithm constitutes a combination of active and passive approaches to solving a Reinforcement Machine Learning class problem. For the purpose of implementing the proposed algorithm, a software architecture is proposed which includes: a main management module which implements the proposed algorithm, functional modules, and information/support modules.

### TECHNICAL FIELD

The declared solution is related to the field of computer modeling which is used in asset management field in order to plan operations with assets and allocate resources for these operations while an enterprise conduct its activities. The main operations with assets include purchase, design, construction, reconstruction, commissioning, repair and maintenance, restoration, provision of standard operating conditions, decommissioning, sale, and utilization.

### BACKGROUND

For the management of enterprise's activities within the full cycle of procurement and sales, the classical MRP II algorithm [1, 2] has existed for a long time, and also APS applications which appeared later, firstly in the SCM systems and then as part of the ERP II systems [3]. They allow answering questions exhaustively:

What raw materials and components, when and whom to buy from?

What, where and when to produce?

When and whom deliver manufactured products to?

Their application provides efficient enterprise's operations activity. In contrast, in the composition of modern EAM- and ERP-systems there are no algorithms and methods of asset management, allowing making decisions:

Which is more efficient—to build and buy new assets or upgrade existing ones? What and where to build? What and where to buy? What and how to upgrade? What existing assets to sell or decommission?

How to allocate resources to support and develop assets in specific areas?

To what extent should repairs and maintenance work be conducted in order to exclude an unjustified profits peak in the current year due to their underfunding, and then to recover lost assets for several years?

In general, assets are understood as a wide range of tangible and intangible objects: buildings, structures, land, construction sites, equipment, software systems, databases, etc.

Many large companies operating in the industries requiring a high level of capital expenditures, own a large assets fleet of tens of millions of units. Such companies include railway companies, electric networks, operators of wire and wireless communications, vertically integrated oil and gas companies, chemical, metallurgical and other companies whose activities often extend to several states or even several continents. For them, assets represent the company's fixed capital, they need answers to the questions formulated above.

Now the budget for the creation, purchase and support of assets is distributed by empirical methods based on theoretical hypothetical assumptions, using distribution strategies that “look right.” Personnel and existing applications cannot provide an optimal asset management strategy. Here is a brief analysis of the used applications, showing that currently there are no methods and applications to find answers to strategic asset management raised the questions:

Production management methods developing independently from MRP II, solve only asset management operational questions, without giving answers to raised the questions. Thus, Lean manufacturing [4,5] supports the decommissioning of unused assets, and Theory of constraints [6]—increasing of assets for bottle necking. However, in both cases, situational operational planning under specific arising conditions is performed. A long-term asset management strategy is not developed.

The existing EAM-systems solve the issues of optimal planning of repairs and maintenance of assets, applying various strategies for this—CBM, TPM, RCM, RBM, etc. [7-9]. However, even using risk-based advanced maintenance planning strategies, EAM systems are not able to take into account economic factors, changes in demand and production, logistics of future commodity flows between production and technology complexes. In addition, EAM systems plan maintenance costs for one specific version of the assets fleet, not taking into account that its composition is a way to achieve strategic goals, and it may change.

Existing project management systems provide planning and control over the projects execution for the assets design, their construction, commissioning, reconstruction, repair and decommissioning. Project portfolio management systems allow optimizing and balancing the composition of the performed projects in accordance with the operational and financial organization's tasks, taking into account the restrictions imposed by customers, strategic goals and external world factors [10-12]. However, due to the large number of possible scenarios, a large assets fleet, their diversity and mutual influence during operating activity, the project portfolio management system cannot form an optimal long-term asset management strategy and, therefore, provide its implementation.

Existing business intelligence systems are able to perform complex inquiries for data analysis in data warehouses, build various visual data representations, use simulation models and predictive analytics methods [13,14]. However, currently there are no developed business intelligence tools capable to find reliable answers to the questions formulated above. Parallel modeling of the performance of the required millions of assets units, taking into account various economic scenarios and different options for projects initiating, requires that the analytical platform work on the basis of BigData cluster, where in each cluster node the work of individual groups of assets in specific conditions would be modeled. So far, there are no analytical platforms on the market, which allow describing the complex logic of processing of different working scenarios with assets fleet that are modeled on individual nodes of a large cluster, and receive recommendations on them.

Existing business intelligence systems are able to perform complex inquiries on the data analysis in data warehouses, build various visual data representations, use simulation models and predictive analytics methods [13,14]. However, currently there are no developed business intelligence tools capable to find reliable answers to the questions formulated above. Parallel modeling of the performance of the required millions of assets units, taking into account various economic scenarios and different options for initiating projects, requires that the analytical platform work on the basis of BigData cluster, where in each cluster node the work of individual groups of assets in specific conditions would be modeled. So far, there are no analytical platforms on the market that allow describing the complex logic of processing of different scenarios of working with the assets fleet, which are modeled on individual nodes of a large cluster, and receive recommendations on them.

Based on the analysis of the history and development trends of corporate information systems, [15] hypothesis was formulated, that management systems capable to give clear answers to asset management questions formulated at the beginning of this document will be distributed in the next decade (2020 2030 yy.) and will relate to the generation of ERP IV.

One of the key components of the invention is the asset master data management system (MDM system). The leading global analytical company Gartner, according to a tradition, annually produced two independent analytical reviews on different classes of MDM systems: one on MDM systems “about things”, which include master data management systems on assets, and the second—on MDM—systems about people, teams and organizations. But in 2017, the company violated this tradition: released a single review on all classes of MDM systems [36]. Analyst company Forester publishes reviews on MDM systems once every two years. In 2016, it published its review [37]. In the listed reviews there is no mention of the fundamental complexity of the implementation of asset master data management systems, due to the need to synchronize different representations of the same assets fleet. Mechanisms of this problem solving are proposed in [38]

### SUMMARY OF THE INVENTION

The invention proposes a formalized approach providing an optimal planning of all operations with assets, including purchase, design, construction, new assets commissioning, reconstruction, repair and maintenance, restoration, provision of standard operating conditions, decommissioning, sale and utilization of the existing assets. Formed optimal plan should be supported by an appropriate budget allocation and take into account financial and other conditions and restrictions in which the company operates.

As any formalized approach supposes the existence of a formal criterion in accordance with which different options of actions with the assets fleet will be compared, it is advisable to select the maximum of the total discounted net profit of the company during the considered period of time as this criterion. This criterion, in our opinion, allows us the most closely estimate a company's economic success. Other possible criteria considered on the basis of the sales volume and the value of the company's capitalization, in our opinion, are less suitable due to the fact that the state of the assets fleet has a smaller impact on these indicators' values.

The total maximum of discounted profit over the future 20-30 years will allow excluding situations when a profit peak will be obtained in the short nearest period of time, and then within a few years lost assets will have to be restored due to under-financing.

The task of maximizing of the selected criterion can be formulated as a kind of some optimal control problem, in which management is carried out through the choice of projects and activities associated with the development and support of assets:

investment projects providing the creation and purchase of new assets, their reconstruction or decommissioning;

innovative projects providing improvement of the used technology and asset performance indicators

activities for maintenance and repairs of assets.

All the potential projects and activities related to the development and support of assets are a kind of integrated management space. To solve the problem, at each step it is necessary to select those of them that will provide the maximum value of the selected criterion.

In addition to the criterion in the stated optimal control problem, there are limitations that reflect the requirements of customers, the external environment, regulators, owners and management of the company. As possible types of restrictions can be considered:

financial (loan rate, exchange rate, etc.);

technical (assets reliability, safety for personnel, etc.);

market (the need to fully satisfy individual consumer groups, product quality requirements, etc.);

environmental (volumes of emissions, deterioration of land quality, etc.) and other restrictions.

Typically, restrictions are fixed in the adopted strategy of the company.

### BRIEF DESCRIPTION OF THE DRAWINGS

FIG. 1 illustrates an example of dependencies between projects located in the same and in different portfolios.

FIG. 2 illustrates an example of a set of projects portfolios for the development of assets of a vertically integrated oil company.

FIG. 3 illustrates the set of annual forecasting periods.

FIG. 4 illustrates the set of annual forecasting periods and a highlighted version of long-term development.

FIG. 5 illustrates a long-term development variant with an indication of changes in the composition of the assets fleet.

FIG. 6 illustrates an example of a supply chain of a company with one-step production.

FIG. 7 illustrates an example of a supply chain of a global company with a single-stage production, whose subsidiaries are located in different states.

FIG. 8 illustrates a block diagram of the algorithm for improving of the stability of the found most likely long-term development variations.

FIG. 9A and FIG. 9B illustrate a block diagram of the algorithm for planning of operations with assets and the allocation of resources on these operations.

FIG. 10 illustrates the interaction of the main management module implementing the long-term asset management algorithm with functional modules.

FIG. 11 illustrates data flows from information management systems to functional modules.

FIG. 12 illustrates the general scheme of the arrangement, from which the cluster implementing the claimed method is composed.

### DETAILED DESCRIPTION OF THE INVENTION

When structuring the space for controlling actions, it is necessary to take into account the differences in capital intensity and profitability of various companies' activities. To do this, in the invention it is proposed to use the method of the portfolio management—to form several groups of portfolios, each of which contains the number of portfolios equal to the number of work-streams:

In the first group, each portfolio connected with a specific type of activity, contains activities related to the maintenance and provision of capability of assets involved in this type of activity.

In the second group, each portfolio connected with a specific type of activity, contains all investment and innovation projects and activities for assets involved in this type of activity, affecting the composition and characteristics of the assets fleet.

In the third and subsequent groups, each portfolio connected with a specific type of activity, contains all investment and innovative projects and activities related to the assets involved in this type of activity, providing a change in the indicator values taken into account in one of the restrictions. For each indicator established by the restrictions, a group of portfolios is formed. For example, one group of portfolios—for activities and projects to provide technical safety and reduce the number of accidents, the second group of portfolios—for activities and projects to protect the ecological environment, etc.

When forming portfolios, projects, work, and activities included in them, sets of characteristics that are different for each group of portfolios should be assigned. All elements of portfolios have characteristics that determine the execution duration and the necessary costs and other resources—the number and qualification of personnel, the necessary technical means and materials. And besides:

In the portfolios of the first group related to maintenance and providing assets capability, each element of the portfolio will be characterized by a set of values on which the occurrence probability of certain types of failures of specific types of assets after this work performance is reduced. This allows ranking the portfolios elements on the effectiveness of maintenance work for specific types of assets. In addition, these portfolios elements should have characteristics determining the need of temporarily suspend of assets use during maintenance performing.

In the portfolios of the second group, related to changes in the composition of the assets fleet and individual assets characteristics, all projects and activities should be characterized by indicators of potential revenues. This allows ranking them by IRR [16] in the portfolio in order to have an estimate of their effectiveness in terms of the target optimization criterion.

In the portfolios of the third and subsequent groups related to indicators changes taken into account in one of the restrictions, all elements should be characterized by estimates of the impact on the indicator taken into account in the restriction. This will allow ranking of portfolios elements by efficiency in terms of upholding of restrictions.

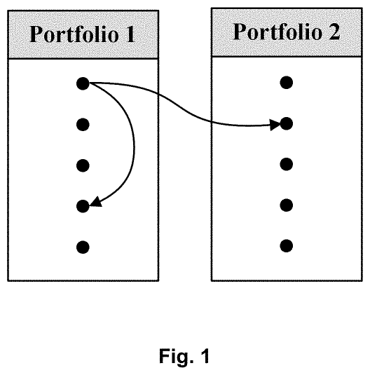

The dependencies on the implementation can be established between the elements within individual portfolios and between the elements of different portfolios, determining that a specific project/activity/work cannot be executed, until all projects/activities/work on which this element depends, as shown in FIG. 1 won't be performed.

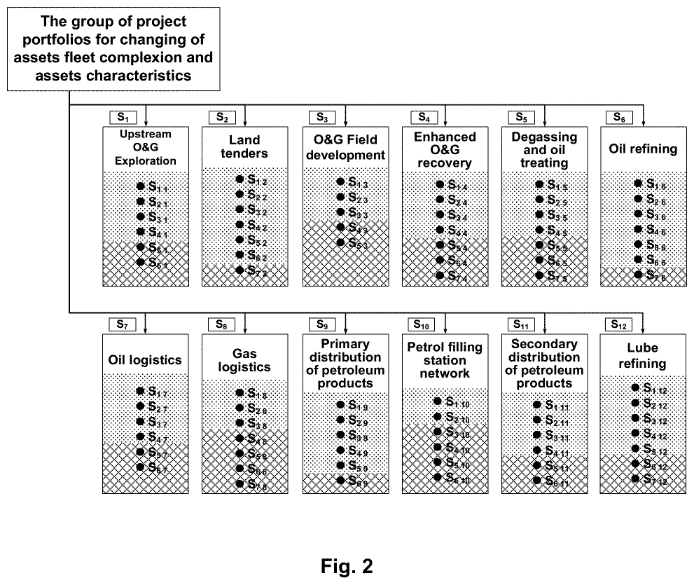

Under these conditions, the budget allocated for each portfolio for a specific period can be considered as a kind of management variable. FIG. 2 shows an example of a set of projects portfolios to change the composition of the assets fleet and assets characteristics of a vertically integrated oil company. Si management variables containing the budget size values of each portfolio, uniquely determine the composition of the projects that will be implemented (small hatching zone) and postponed (large hatching zone). The general list of the budgets of all formed portfolios determines the dimension of the complete space of management variables.

For enterprises engaged in the production of tangible products, portfolios should include all projects/activities/work related to tangible assets (buildings, structures, equipment, land, building objects, etc.) and their components, as well as with intangible assets used in the company's activities (software systems, databases, patents, etc.).

If an enterprise uses any natural resources in its business, as in the case with oil company, a company producing agricultural products or a company dealing with fishing and fish processing, the available natural resources must be considered as assets of the company. This allows setting and clearly following the strategy for the use of such resources, depending on the degree of their availability and the need to expend efforts to restore them. In the case of non-renewable resources, using an extensive strategy, one can collect easily accessible reserves with a minimum of costs, but, on the contrary, can make additional efforts to extract maximum of the hard-to-reach reserves. It is also possible a large number of different intermediate strategies. Similarly, in the case of renewable resources (land for agricultural production, forest, fisheries), it is possible to make or not to make efforts for their renewal, and various intermediate strategies are possible. The application of a particular strategy is determined by the indicators established in the restrictions.

The use of assets depends on the demand for the company's products. Due to the fact that the development is a method (algorithm) that allows forming an optimal asset management strategy over a long period of time, the demand and restrictions imposed on the company should also be determined for the entire period of the developed strategy. Quantity demanded varies over time and is determined by the following factors:

the strategy used to produce products and provide services, determining the types of products, potential consumers and sales regions;

trends in the development of specific sectors of the economy in the regions of presence;

business climate in the regions of presence and the regulatory rules in force at each time point;

volume of market demand for each product group;

availability of raw materials;

production capacity of the company, which is determined by the existing assets and human capital;

actions and production capabilities of competitors.

To concretize the forecasts of demand and restrictions that will be imposed on the company, it is necessary to divide the entire forecast period into relatively short periods of time. In accordance with common practice, the authors divide the entire forecast interval into a sequence of annual periods: from the nearest planning period to the last period ending the time interval for which an asset management strategy is developed.

In order to take into account the multivariance of the future development, the authors use a scenario approach, in which the authors consider several different development scenarios—basic, moderately optimistic, optimistic, moderately pessimistic, pessimistic, etc., each of which has some initial probability to be realized. It is scenarios that determine the business climate, technological capabilities, resources availability, and other indicators that affect demand and restrictions forecasts in the first year period.

To simplify, discrete transitions between different scenarios-make them possible only after the end of the next year. Each scenario, each transition will be characterized by a certain probability. Then you can consider several options for the transition from the next ended annual period to the next, and this, in fact, will be the next level of scenario detailing.

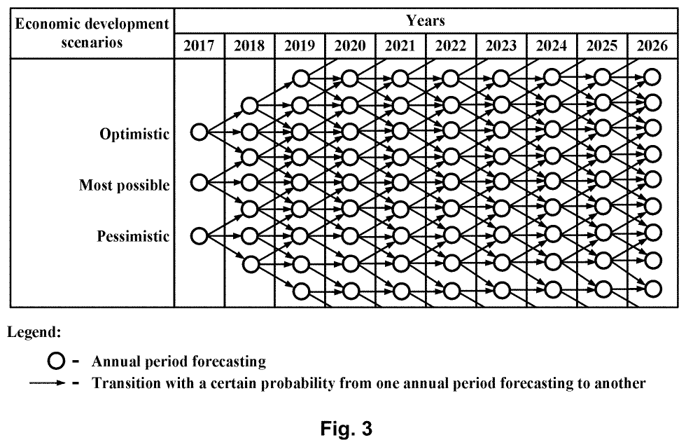

To exclude transitions with very low probabilities from consideration, the authors use for forecasting a corridor of scenarios with a fixed width, and the authors will not consider development scenarios beyond the boundaries of the corridor. FIG. 3 shows the total amount of the considered annual periods with three initial development scenarios and a total forecasting with 10 years duration. These restrictions are used so that the drawing is not too small. The width of the used scenario corridor is equal to 9.

If a company operates in several regions with different conditions, sales forecasts and restrictions for each annual period should be made separately for each region.

The previously listed factors influencing demand make its forecasting for each annual period a very difficult task. To solve it, different approaches can be applied (based on subjective assessments and based on sales history), various mathematical models and methods (time series analysis, cause-and-effect analysis, etc.) [17]. For different product categories—niche products, new products, growing brands and products being withdrawn from the market, various forecasting methods are used. There is a special peculiarity in forecasting the demand for spare parts [18], forecasting the demand for electricity [19], and forecasting the demand for services and for transport services in particular. The mathematical apparatus used to forecast demand is very diverse and covers most sections of modern applied mathematics. Artificial intelligence methods, such as neural networks, evolutionary methods, etc., are more wide-spread for these purposes. The diversity of the applied approaches of models and methods is typical not only for demand forecasting, but also for forecasting of restrictions size that will be imposed in different periods.

The solved problem of the optimal management of the assets fleet belongs to the class of Reinforcement Machine Learning problems [20], in which it is necessary to adopt and implement a sequence of decisions leading to the best result, in the conditions of constant context. Due to the fact that the intensity of decision making is low (once a month or once a quarter) and there is enough time for calculating and estimating the set of possible variants, it is proposed to use a specially developed method that combines passive and active approaches of Reinforcement Machine Learning. Further, this method will be described in detail.

An important feature of the solved problem is that transitions between different variants of long-term development are performed mainly under the influence of external factors, and not as a result of decisions made at each step. That is why, in the framework of the proposed method, by analogy with passive approaches, it is proposed to calculate the optimal sequence of projects and activities over the entire depth of the forecast period for a variety of long-term development variations having a relatively high probability, and then select one most likely variant and increase its resistance to external changes by using the results of the calculation of other options.

For higher adaption to changes in external conditions, the developed method must have features peculiar to active Reinforcement Machine Learning approaches. The active component is implemented as follows:

After calculation of all options and the formation of the optimal solution for the next period, its implementation begins and, in parallel, the collection and preparation of actual data for the next calculation.

The entered data may entail a change in the corridor of the analyzed scenarios for long-term development.

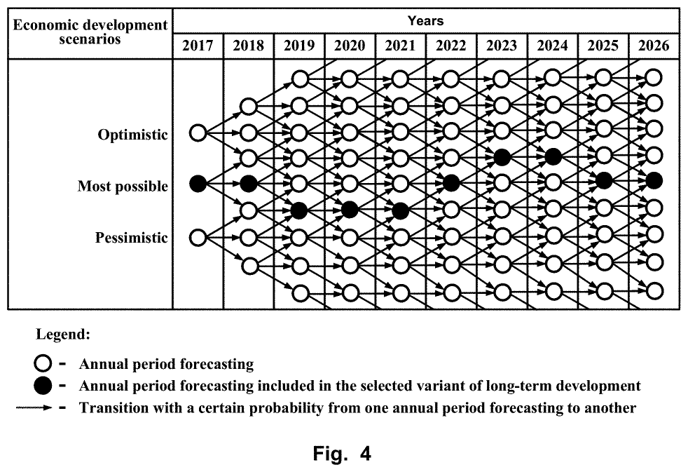

Formed demand and restrictions forecast is the basis for generating of long-term development variations covering the entire asset management period which is considered. Each sequence of interrelated annual periods, for example, as shown in FIG. 4, can be used to form a long-term development variation.

As each transition to the next annual period is characterized by a certain probability, the general probability of the long-term development variation will be equal to the bundle of the initial probability of the selected scenario and all the probabilities of transitions between incoming annual periods. In order not to analyze unlikely long-term development variations, only those of them that have a general probability greater than some P value will participate in the search. This will allow excluding from consideration such unlikely options, when the long-term development scenario for some time developed over annual periods at the lower border of the corridor, which have a low probability, then quickly slipped through the middle of the corridor and further developed over annual periods at the upper border of the corridor, which also have low probability.

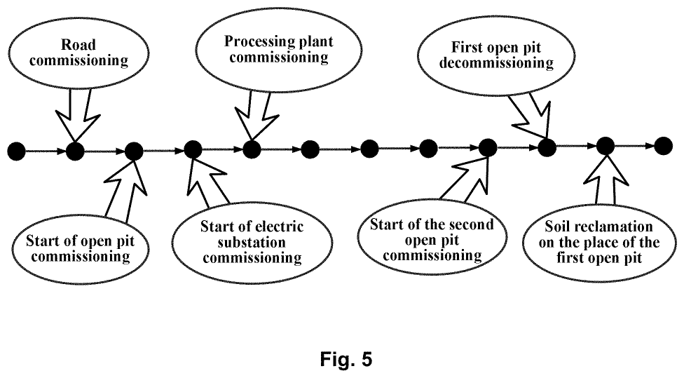

In order to fully determine a specific variant of long-term development, it is necessary to determine the commissioning and decommissioning points of specific production and technological complexes, as shown in FIG. 5.

The types of created, acquired and decommissioned assets, and their main characteristics are defined in the projects portfolios providing the change in the corresponding assets fleet, as the results of these projects performance. In order to have an asset by a specific date in a long-term variant, in advance, based on the duration of the project, the relevant project must be started, and appropriate resources must be allocated for its implementation.

Different projects in the same portfolio for the creation or purchase of assets may result in the creation of different or similar production and technological complexes in different regions. They can also plan the creation of production capacities for completely different development scenarios, for example, create capacities for the extraction of raw materials or create a transshipment center for obtaining raw materials by sea from abroad.

The task of finding the optimal content of a long-term development variation with specific assets is a combination of the task of drawing up an optimal project schedule under conditions of resource limits and optimal allocation and distribution tasks with restrictions. An efficient way to find approximate solutions to each of these problems is to search using genetic algorithms [21]. The same approach can also be used when searching for a given criterion for the optimal filling of a long-term development variation with specific assets based on demand forecasts and restrictions. Moreover, in order to speed up the optimization process, various modern developments in the field of genetic algorithms [22] and parallel genetic algorithms can be used [23].

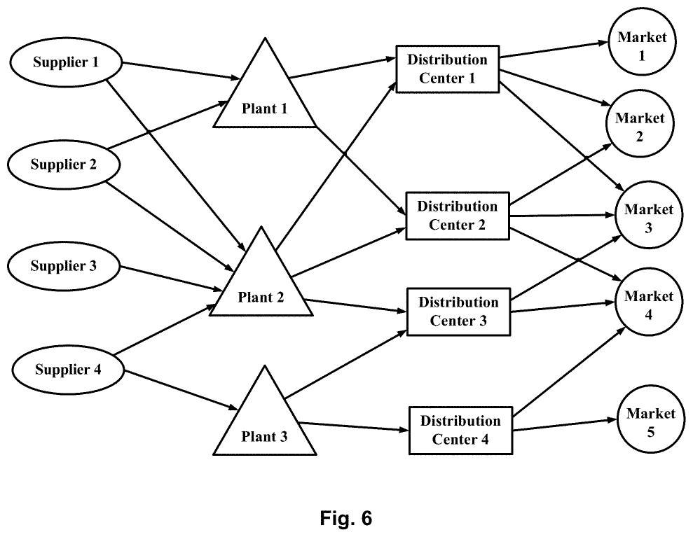

In order to estimate which production and sales program will be carried out within each annual planning period as part of the considered long-term development option, it is necessary, based on the already known composition of production and technical complexes and known estimates of demand, to form a plan for purchase, production and sales. So, the authors need to plan all supply chains for a period of one year. An example of such a chain is shown in FIG. 6

FIG. 6 shows an example of supply chains which is relatively simple:

1. Goods movement occurs only in one direction: from suppliers to factories, from there to distribution centers of finished products and from them to market zones. However, in many companies and industries there may be features that require a more complex logistic scheme. For example:

it is necessary to return and utilize goods that have been used up, as is done in many countries for tire covers and accumulators;

it is necessary to provide logistics for the products recall that consumers refused after the purchase, in the case of mass-market products;

due to the discrepancy between the planned and actual demand, it may be advisable to move inventory between distribution centers.

2. In the presented example, the production is turned out in one stage—the ready-made products are immediately produced from raw materials. However, in real companies, things can be more complicated:

the company can deal with distribution and not have its own production, only logistics centers;

Often the production is carried out in two stages—semi-finished products are produced from the initial raw materials at the first processing plants, and then final products are produced from the second processing plants;

in companies of the iron and steel industry, three process stages are used (iron production, steel production, rolled steel production). In gas chemistry there is an even greater number of process stages;

There are enterprises in which production is built in a combined way—some of the final products are produced according to a single-processing scheme, and some to double-processing scheme.

3. In the presented example there is only one echelon of distribution centers between plants and market zones. However, intermediate logistic centers can also be used between suppliers and factories, as well as between plants performing different stages of production in multi-stage production. Moreover, in each case there can be not one echelon of logistics centers, but several. For example, when the raw material from the supplier is transported by sea, the warehouse center at the port of dispatch and the second at the port of receipt can be used.

In order to plan optimal supply chains within annual periods for a wide range of enterprises, it is necessary for the planning mechanism to be able to solve these problems, taking into account all the listed options of production organizing and trade flows structure. For constructing optimal supply chains, linear programming methods have long been used [24]. With their help, it is possible to determine the production volumes of each type of product at each plant and trade flows volumes for each transport route, which will ensure the maximum company's profit. Supply chain optimization models can be built on the basis of different principles, for example:

It is necessary to ensure that all customers' needs are satisfied in all market areas.

The found optimal production and transportation plan does not necessarily have to satisfy all customer requests, it is necessary to maximize the use of existing assets.

Various intermediate options when it is necessary to ensure the compulsory satisfaction of the needs of only individual customers with whom special long-term contracts have been signed, guaranteeing full satisfaction of applications for the supply of all or specific types of products.

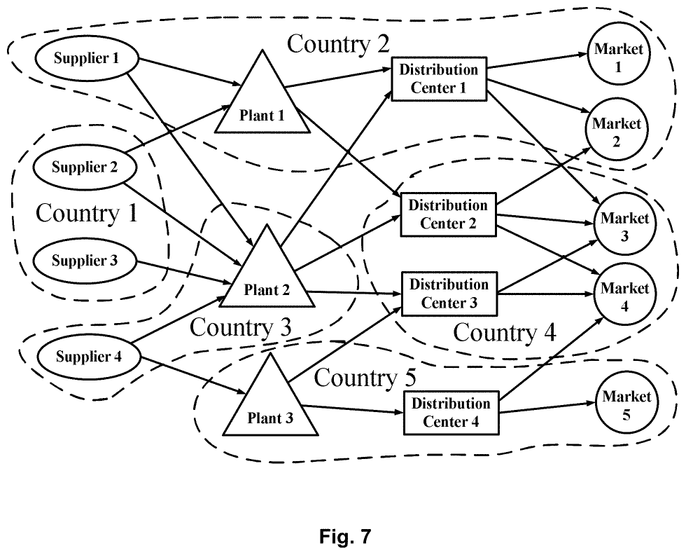

However, if the company's extractive, production and distribution facilities are located in different states, as illustrated by the example of the same supply chain structure in FIG. 7, or in different economic zones that differ in taxation, then linear programming models do not provide supply chain optimization [24].

To optimize such supply chains, bilinear models are used, where the maximization criterion is the profit of a global company, and as variables are not only transportation volumes are used, but also transfer prices between individual subsidiaries are used [25]. Varying of transfer prices within acceptable limits allows optimizing the profits of multinational companies, taking into account different laws and different tax rates.

Bilinear models need to be used in planning of internal supply chains of multinational companies, but also for mono-national companies in a number of industries connected with continuous production, such as oil and gas processing, chemical production. This is due to the fact that in these cases, different amounts of semi-finished products and final products can be got from the same raw materials in the same installation at different processing modes. Mathematical model of the supply chain, including such an installation, will describe several virtual installations by the number of possible operation modes and variable coefficients, which determine the portion of time of the installation use in each mode. By its mathematical essence, this is also a bilinear task.

If an oil company owning petroleum-refining plants has subsidiaries in different countries, then a trilinear mathematical model to optimize its supply chains must be used.

The described linear, bilinear, and trilinear models cover most needs in supply chains optimizing. However, there are cases when material entities that do not have a real form (electricity, information) are transported or non-traditional transportation methods are used. Such cases require the use of special models. For example, if a company deals with production and sale of electricity, the supply chain model in this case should describe the electrical network. Electrical networks modeling requires the use of specialized models and special software means [26,27]. In other cases, when special types of models are required, you can provide access for subscribers to cellular communication or a television signal, transfer of water resources through a channeling, or such exotic things as providing with fresh water by means of icebergs from the Antarctic.

In the case when the company's activities are diversified, and individual areas do not meet, it would be advisable to use several parallel working models for supply chains optimizing so as not to build an integrated bulky one. The simultaneous use of two or more models is absolutely necessary if, due to the specificity of supply chains, it is required to apply models of different types. As an example of a company where it is necessary to use several models of supply chains in parallel, one can exemplify the holding company for state assets managing of the Republic of Kazakhstan, which is under the control of the government, ‘National Welfare Fund «Samruk-Kazyna»’ Joint Stock Company [28]. The holding has united over 500 subsidiary and dependent organizations and affiliated legal entities. Among other assets, the holding owns:

the national company for the extraction and transportation of oil and gas “Kazmunaygas” JSC;

“National Mining Company “Tau-Ken Samruk” ” JSC;

the national company for the production and distribution of electric and thermal energy, as well as the extraction of thermal coal “Samruk-Energy” JSC;

the national electric networks management company “KEGOC” JSC;

the national railway company “ [symbol] [symbol] ” JSC;

“Kazatomprom” JSC;

“Kazakhtelecom” JSC.

The models of supply chains used in this holding for planning operations with assets will be wider than the boundaries of subsidiaries, as for the electricity generation you can use both coal mined in open pits near power stations, and fuel oil supplied by railways from oil refineries.

To estimate the state of complex technical systems since the early 1960s, the theory, methods, and special FMEA models (FailureModeandEffectsAnalysis) [29] were developed and used, which were later expanded to FMECA (FailureMode, Effects, and CriticalityAnalysis) [30]. It is advisable to use these theoretical approaches and methods for estimating the extent to which the existing assets fleet allows implementing of the calculated optimal supply chain plans, as well as to check compliance with the established restrictions. The FMEA/FMECA approach can be used for various types of objects:

technical systems (machines, software products);

business processes;

provided services and at different stages of their life cycle:

at designing;

at introduction (purchase);

after completion of a certain operation stage.

As FMEA/FMECA models the following can be used:

stochastic programming methods that minimize risks;

methods of the theory of fuzzy sets and multi-criteria decision making [31];

methods of artificial intelligence and machine learning (an example of the use of machine learning for technical condition estimating is given in [32]);

simulation modeling methods (founded by us the earliest example of using simulation models to estimate the influence of various maintenance strategies on the assets performance and their ability to satisfy users' needs is contained in [33]).

In assets fleet strategic management problem solving by us, from the point of view of the asset life cycle, a combined approach should be used, as the part of assets are already in use, and they can be used to collect actual failure statistics, and some of the assets will only be acquired/built, and information about them must be requested from suppliers, sought in independent sources or make prospective estimates independently. As the Internet of things spreads, the collection of information about functioning and failures of existing infrastructure objects, equipment and vehicles will become mostly automated. An example of a solution which is able to provide such data collection is the SAP Leonardo platform [34].

As the assets fleet includes a large number of relatively independent assets connected only by supply chains and production processes, it is advisable to decompose the task and use a great number of independent models, each of which works with one physical asset. A group of such models will allow covering all the components of the assets fleet. The required simulation models complex is generally similar to the agent model, as each of the models works independently, but the main difference from the agent system is that the results of each simulation model's work do not change a certain general data structure, and are issued to use upward in the algorithm and the formal model of a higher level.

When choosing the used models to estimate the technical condition of the assets at the initial stage, when assets strategic management systems only begin to spread and gain recognition, the most advisable is to use simulation models. They allow, within the framework of a single modeling process, not only to estimate asset's ability to perform the planned job scope, but simultaneously, after a small model complication, to estimate restrictions maintenance. When using other types of models, several different models will have to be used in parallel. Of course, the use of methods and models of machine learning, including methods based on multilevel neural networks (DeepLearning), will help to take into consideration not only simple dependencies of failures occurrence on the operating time, but the influence of many other factors on the failures occurrence. However, in order for these methods to start working, it will be necessary to collect more complex failure statistics considering additional factors.

Obtaining estimates using simulation modeling assumes that during the entire annual period for which the supply chain was planned, the impact of failure flows on the components of the production and technological complex is simulated. The maintenance and repair work carried out in accordance with the allocated budget for a certain period, reduces probability of failures or restores the performance of the components, and also reduces probability of events regulated by restrictions. Innovative projects can increase the productivity of the industrial and technological complex or change the characteristics of the failures flow. Investment projects initiate the occurrence of new groups of simulation models.

When using simulation models to simulate an assets fleet, you can make assets' typization and restrict yourself to the development of one model for each type of asset. In order to fully define the model of one type of assets, it is necessary to determine:

all types of failures occurring in this type of assets;

the statistical distribution of the occurrence of each type of failure;

the consequences of the occurrence of each type of failure, both in terms of indicators and asset's performance, and in terms of events and indicators regulated by restrictions;

all types of repair and maintenance work for this type of asset;

the impact of each type of repair and maintenance work on the statistics of the occurrence of each type of failure.

After repeated run of simulation models for each production and technological complex involved in the planned supply chain, statistically reliable estimates are formed:

the ability of the complex to complete job scope, determined by the optimal variant of supply chains;

indicators regulated by restrictions.

While simulating modeling of the state of assets within an annual period, it is necessary to fix the state of assets at the end of the year, and the modeling of the next annual period within the framework of one option of long-term development should begin namely with this condition. This will allow taking into account the impact of the performed work of repair and maintenance of assets on their subsequent performance.

To estimate the capabilities of natural assets, special types of modeling needed to be used. For example, to estimate the results of a certain set of oil field development projects, it is necessary to use hydrodynamic models. Each hydrodynamic model will provide a forecast of oil output of a specific field during the required time interval, taking into account the implementation of all projects for drilling, wells repairing and carrying out geological and technological procedures at this field. In the case of oil company asset management, the inclusion of hydrodynamic models and corresponding simulators in the structure of the created complex is due to the inability to predict in advance the results of joint implementation of various projects. You can calculate the results of each individual project under given initial conditions. However, projects carried out in the same field affect the performance of each other. Therefore, the total volume of production can be determined only with a specific list of projects, determined by the chosen option of long-term development.

Approximately similar situation with oil fields occurs in mineral deposits mined in a solid state. Different projects for the construction and modernization of mines and open pits may have an aim to extract intersecting mineral resources. It is necessary to use the geological model of the field to predict the results of different projects.

For renewable natural assets (agricultural land, forests, fisheries, etc.) also require their own specific models allowing estimating the amount of resources extracted depending on the initial state of the asset, held activities and general trends in the natural environment.

The results of joint modeling using the entire required set of models will allow forming an estimate of the feasibility of the planned supply chains.

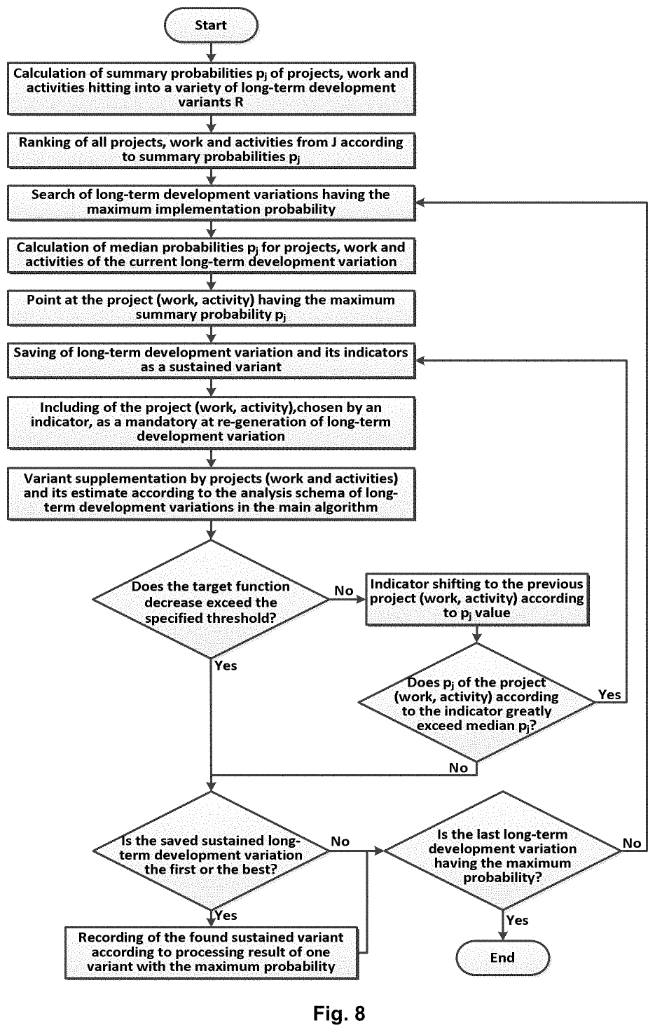

After generating of long-term developmental variations, optimizing them, and sifting out those that do not provide the performance of the established optimal plans and do not match with the established restrictions, a sequence of actions aimed at increasing of the stability of the most likely long-term developmental variations is performed. The block diagram of the algorithm for stability increasing of the most likely variant of long-term development is shown in FIG. 8 (100).

As a result of the prior steps, the authors get many variations for the long-term development R, in which each variant rᵢ∈R, i∈1,n is characterized by pᵢ probability and the value of the target function Vᵢ, which is the discounted expected profit during the whole time interval of assets management. The choice of one or another variant is determined by external conditions, each variant is optimized for its time-varying forecasts of demand and restrictions, and therefore it is impossible to control the value of the target function, moving from one long-term developmental variation to another.

Each long-term developmental variation rᵢ∈R includes many Q projects, work and activities qᵢⱼ∈Qi, j∈Jᵢ. A set of indexes Jᵢ∈J includes only some indexes of projects, works and activities from the number of J=1, m. Each qᵢⱼ∈Qi has a common probability for all elements of the variant pᵢ. For all qᵢⱼ, j∈Jᵢ; i∈1, n, it is possible to calculate total probabilities pⱼ of hitting of projects, work and activities in a number of variants of long-term development R (101) using the following formula:

$${p}_{j} = {\sum }_{i = 1}^{n} \begin{matrix}{p}_{ij} \vert j ∈ {J}_{i} \\ 0 \vert j ∉ {J}_{i}\end{matrix} , j = 1 , m$$

After that, it is necessary to rank all projects, work and activities from J by the pⱼ value (102).

The algorithm (100) was developed taking into account the fact that not one, but several variants of long-term development can have the same maximum probability of realization. In the cycle, these variants are sorted out (103), (113).

For each of the most likely long-term development variation Rₘₐₓ, having the value of the target function Vₘₐₓ, the median pⱼ value is calculated for qᵢⱼ, included in this most probable variant (104).

In order to increase stability of Rₘₐₓ variant, the possibility to add in Rₘₐₓ not included projects, work and activities in Rₘₐₓ is studied, where pⱼ exceeds the median pⱼ value for Rₘₐₓ (for example, two or more times (111)) without significant loss of the target function value. For this aim, starting with the element having the maximum value pⱼ (105), these elements are added one by one (110) as mandatory (107) when re-generating of the most likely variant of long-term development using a genetic algorithm. After each addition, the obtained variant will be supplemented with projects, work and activities, and also its estimate in the same way as in the preparation and analysis of variants in the main algorithm for problem solving (108). The process continues until the obtained deviation of the value Vₘₐₓ does not exceed a certain established liminal value (109). Each time, the last variant is saved, satisfying all the conditions, including the restriction on the deviation of the target function (106).

After completing the processing of a single long-term development variant that has the maximum probability, a comparison with the results of processing of other such variants is made (112) and selecting one of them that has a higher sum of probabilities of included projects (works, activities) (114). And with equal sums of probabilities—the one that ensures the achievement of a greater total discounted profit for all periods. As variants may include a different number of elements, not just the variant with the maximum sum pⱼ of all incoming projects is chosen, but the variant with the maximum specific output, i.e., the largest sum pⱼ of all incoming projects (works, activities) divided by the number of incoming projects (works events).

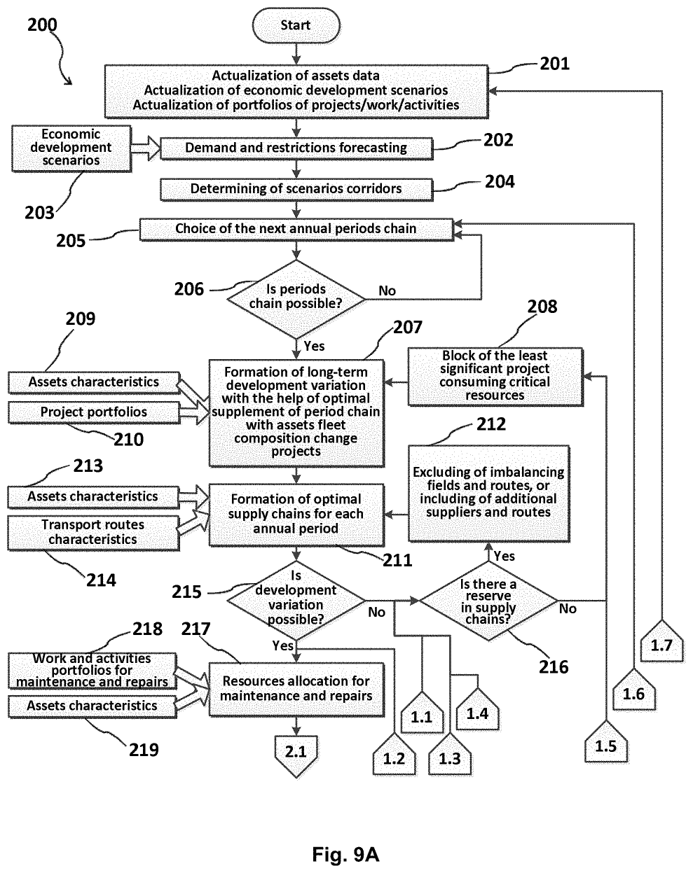

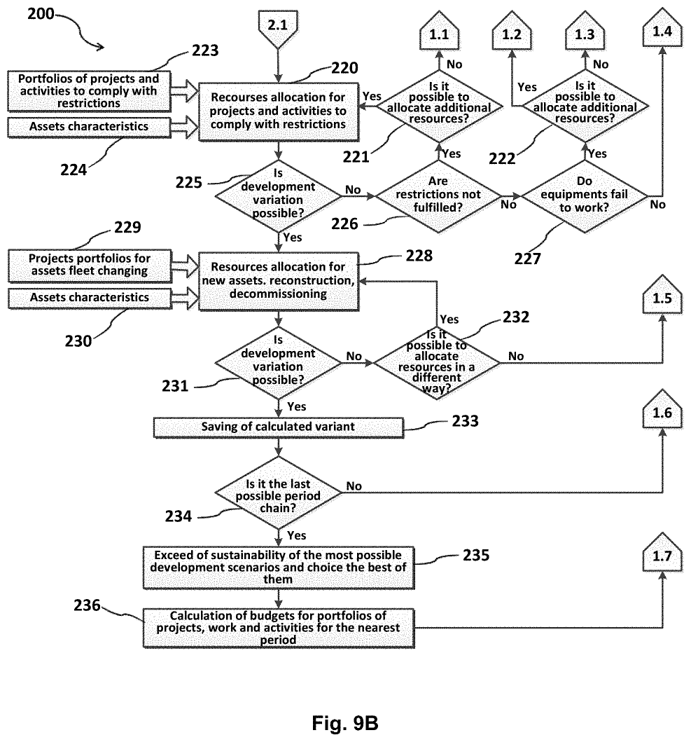

To search the answers to the asset management questions raised at the beginning of this specification, a cyclic algorithm presented in FIG. 9 is proposed (divided to FIG. 9A and FIG. 9B for better presentation), one total cycle of which must be completed at the beginning of each planning stage in which the budget is distributed, and detailed work plans are determined. By analogy with the MRP II algorithm [35], the proposed algorithm assumes the generation and exhaustive search of a large number of long-term development variants with excluding of not realizable variants and preserving the most successful ones, corresponding to a given criterion and satisfying all the restrictions established for different scenarios of economic development.

According to FIG. 9A and FIG. 9B, the claimed method (200) and the algorithm of its implementation together with the hardware-controlled complex work continuously, realizing sliding planning. After completion of one total cycle of exhaustive search, the optimal action plan (236) and the distribution of the budget for the nearest period (quarter or month) (237) are determined. The found plan begins to be used in the company's activities, the budget for the nearest period is distributed according to the found optimal distribution, and the algorithm returns to the beginning (201) in order to plan the next period.

At the first step of the algorithm (201), assets data, economic development scenarios and portfolios of projects/works/activities are updated. After that, in the second step (202), a forecast of demand and restrictions is made based on the introduced scenarios of economic development (203). Then the scenario corridor (204) is determined and the search for chains of annual periods begins (205, 234). Each considered chain of annual periods is a sequence of annual periods from the nearest planned period to the last period ending the optimal planning time period. The chosen chain is checked for permissibility (206) and the optimal variant of long-term development for it (207) is generated based on the information about characteristics of the assets (209) and the entered data on the composition of project portfolios (210).

As the next year ends and the initial period of annual planning is postponed, the final period is also postponed, providing a constant value of the forecast time interval used in asset management.

Analysis of each variant of long-term development begins with the current state of assets; further different variants may develop differently due to the passage through different chains of periods, choice of different scenarios of long-term development, differing demand forecasts and restrictions, probability character of the responses of estimates of feasibility models generated optimal supply chains and compliance with established limits.

The first verification of feasibility of the formed variant of a long-term development (215) is made after calculating the optimal annual plans of supply chains (211), taking into account the assets characteristics (213) and transport routes characteristics (214). If in the process of verification of plans feasibility there are situations that some mandatory product deliveries cannot be fulfilled, the production facilities stand idle due to the inability to transport raw materials, etc., unreliable elements are excluded from the supply chains (based on the characteristics formed as a result of verification) or additional elements are included in supply chains (212), and they are replanned. When it is impossible due to the lack of reserves in supply chains (216), the least significant project requiring critical resources (208) is forcedly blocked and there is a return to a generating stage of a new optimal variant for long-term development (207). Such an approach to the project management for assets fleet development projects will allow, for example, switching from raw materials extraction to its purchase from external sources, or switching to the production of other products.

If the long-term development variant passes the first reasonability check (215) (all suppliers, factories and distribution centers are able to fulfill the calculated optimal plans), maintenance and repair activities (217) are planned based on assets' characteristics (218) and entered data on the composition of portfolios and MRO activities (219). In the next step, projects and compliance measures (220) are planned based on assets characteristics (223) and data entered on the composition of portfolios and compliance measures (224).

Planning maintenance and repair work and activities begins with the most economical variants requiring fewer resources. Then, a check is made on the feasibility of a formed variant of long-term development (225). If at some annual period restrictions (226) are violated, a transition to the planning of projects and compliance measures is made with the allocation of a larger amount of resources (221,220). If at some annual period there are no assets capable to fulfill the planned annual program (227), a transition to the re-planning of works and activities for maintenance and repairs is realized with the allocation of more resources for this purpose (222, 217).

In cases when estimate of the results of planning (225) is carried out only with the help of a set of simulation models and special models of natural resources, due to the high requirements of such a verification to calculating power, the results of planning are estimated together both from the point of view of compliance with restrictions and feasibility of optimal supply chains.

In case if further increase in resources for maintenance and repairs becomes impossible (221), a transition to re-formation of annual supply chains is made (216, 212, 211). Similarly, the transition to the re-formation of annual supply chains is carried out, if further increase of resources for projects and compliance measures are impossible (222). When re-formation of annual supply chains does not allow reducing resource requirements, the least significant project consuming critical resources is blocked (208), and a transition to the generation of a new variant of long-term development (207) occurs.

After determining the minimum required amount of resources for maintenance and repairs, restrictions compliance, all remaining resources are allocated for the implementation of projects for purchase, construction and commissioning of new assets, as well as reconstruction and decommissioning of existing assets (228). While planning of these projects, assets characteristics (230) and entered data on the composition of projects portfolios to change assets fleet, are taken into account (229). After the allocation of resources, an estimate is made (231) of whether there are enough resources (including financial) to realize all the projects necessary for occurrence of the assets requiring at subsequent annual periods. If assets necessary for subsequent periods do not appear, verification is made whether it is possible to allocate resources in a different way (232). If so, an attempt to redistribute resources on projects is made. In case of the exhaustion of opportunities for redistribution, the least significant project consuming critical resources is blocked (208), and a transition to the generation of a new variant of long-term development (207) is produced. If the long-term development variant successfully passes all the checks, then it is remembered (234).

For saved variants having the same maximum realization probability, the algorithm for stability increasing (235, 100) is performed and the best one (112, 114) is selected. For the selected variant, budgets of projects of work and activities for the nearest period are calculated (236).

To implement the described algorithm (200), the following software is proposed to be used:

The main management module implementing the long-term asset management algorithm;

Functional Modules:

Module for formation of annual periods' chains;

Module for formation of optimal long-term development variations;

Module for planning of maintenance and repairs;

Module for planning of activities and restrictions measures;

Module for projects planning that change the composition of assets fleet (purchase, construction, commissioning, reconstruction and decommissioning of assets);

one or a set of several modules for forecasting of demand and restrictions;

one or a set of several systems for optimizing of internal supply chains;

one or a set of several Complexes of asset state modeling to estimate the feasibility of plans;

Information and Support Modules:

System for maintaining of economic development scenarios;

System for managing of portfolios of projects, work and activities;

Master data management system of assets.

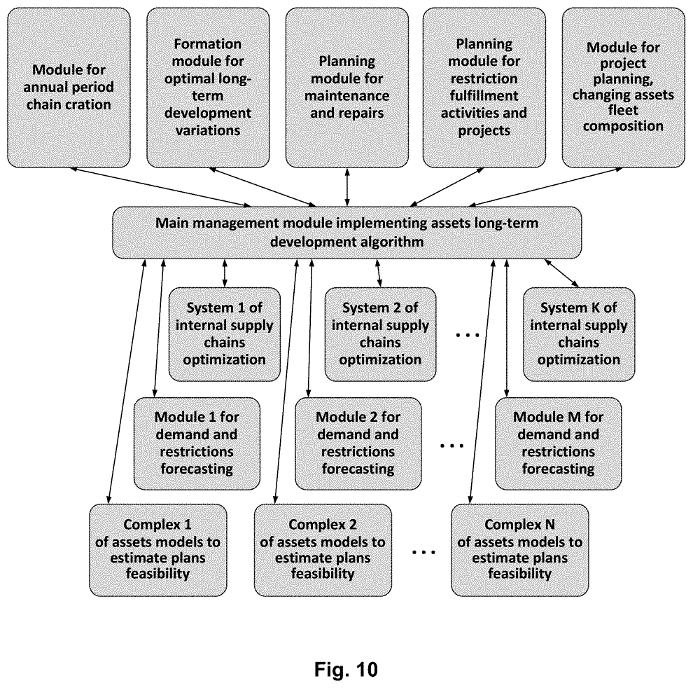

The main management module implementing the long-term asset management algorithm organizes the operation of all functional modules, as shown in FIG. 10.

The module for formation of annual period chains works with all the chains (sequences) of annual periods. The module for formation of optimal variants of long-term development works with all annual periods of one chain and generates from it a variant of long-term development, filling this chain with projects. The remaining functional modules work with one annual period as part of a long-term development variation, detailing and checking work plans for this period.

Among information and support modules, master data management system plays an important role. It should provide several different views of master data of assets:

for the long-term planning process (used in project description and in long-term development variations);

to form optimal goods flow in optimization systems of supply chains;

to allocate resources for maintenance and repairs;

to allocate resources for activities and restrictions measures;

to model the dynamics of assets state;

to allocate resources for new assets, reconstruction and decommissioning of assets

Different master data representations will vary in the level of assets detailing, the principles of assets allocation, the stored characteristics of the assets, and the relationships between assets. It is explained in the following examples:

Production and technology complex in terms of medium-term planning will be presented as a single asset with a set of indicators of performance, fixed and variable costs, etc. In terms of estimating of the cost of maintenance and repair, the production and technology complex will be presented as a set of interrelated pieces of equipment each with its own characteristics of failures occurrence, types of maintenance, etc.

Oil and gas field to estimate the feasibility of plans with the help of simulation model of failures flow, can be represented as a set of well clusters and ground and dipping equipment placed on them, which is lowered into the wells at different levels. To solve this problem using the hydrodynamic model—the field will look like a set of oil-bearing beds and gas-bearing stratums located in three-dimensional space.

In each shown case, different representations will describe the same assets fleet.

The need to use different representations of master data of assets for the same physical objects may arise not only as a result of using of different models to forecast the assets state, but also within one model. A very illustrative example is the set of parallel usable different views of a skyscraper, detailed by floors:

description of general construction;

description of lift industry;

description of air conditioning and ventilation;

description of water conduit and waste-water disposal systems;

description of heating facilities;

description of power supply facilities;

description of fire and burglar alarm facilities;

description of communications and network equipment facilities;

description of interiors;

description of use (distribution of compartments between tenants or business units of the owner).

The use of master data management system of assets should provide synchronization of different representations of master data on the same assets and eliminate possible contradictions between them. This will make possible to prevent data degeneration and reduce costs of keeping them up-to-date.

The project portfolio management system should provide the maintenance of all project portfolios, work and maintenance and repair activities, restrictions compliance, construction, purchase, commissioning, assets reconstruction and decommissioning.

The conduction system of economic development scenarios should contain a wide range of information about the regions in which the company operates, the peculiarities of the economy and labor resources in these regions, customer segments, the company's product line, competitors, initial economic scenarios and prospects for their subsequent development.

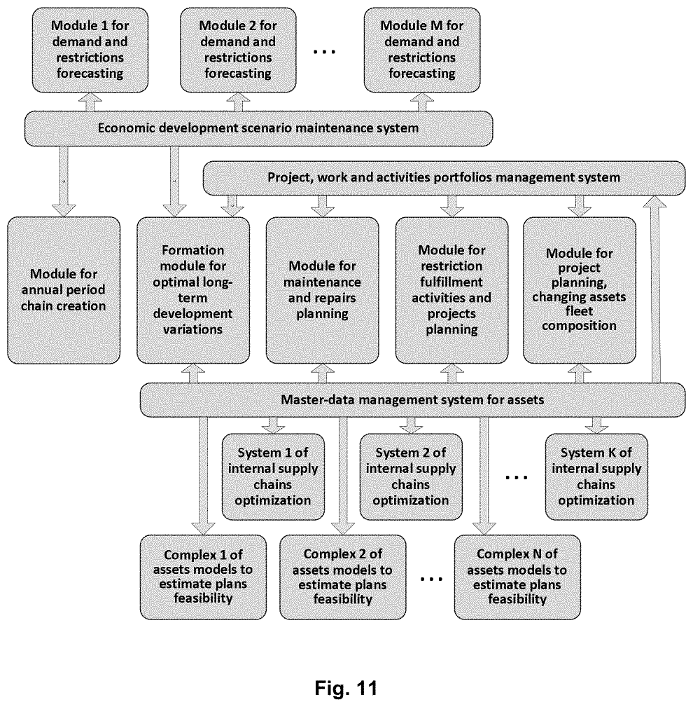

The general scheme of data issuing from information support systems to functional modules is presented in FIG. 11.

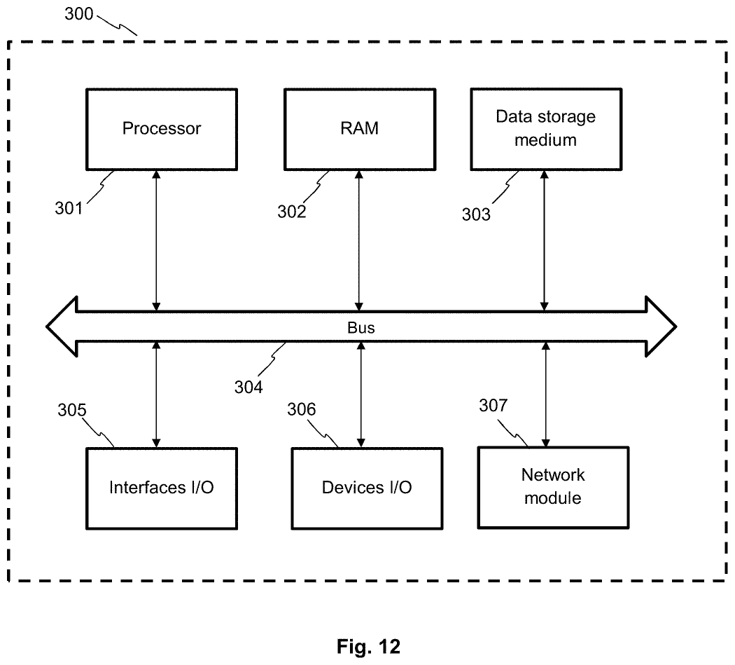

The implementation of the proposed long-term asset management algorithm (method) should be implemented using BigData clusters [39], which can consist of a large number of servers whose architecture is shown in FIG. 12. Each of these servers files some of the data stored in its own RAM or the external memory. This approach will allow:

perform in parallel a large number of simulation processes of failures flow of technical assets;

perform parallelly search for local maximums of bilinear and trilinear problems of internal supply chains optimizing in terms of the presence of discontinuities of the optimized function;

solve problems of hydrodynamic modeling to estimate oil recovery fields or other tasks requiring resource-intensive parallel numerical calculations.

The use of BigData clusters will allow calculating in parallel various variants of long-term development and increase the number of considered variants in search of the best one.

Presented in FIG. 12 architecture of one server included in the cluster (300) includes the following components:

Random access memory (RAM) (302), destined for operational storage of instructions executed by one or more processors (301) and operational temporary storage of working data.

Data storage device (303) in the external memory can be a hard disk (HDD), solid state drive (SSD), flash memory (NAND-flash, EEPROM, SecureDigital, etc.), optical disk (CD, DVD, BlueRay), mini disk or their complexes.

Input/Output (I/O) Interfaces (305) are represented by standard ports and sensor interface devices and data transmission, selected based on the required configuration of the system (300), in particular: USB (2.0, 3.0, USB-C, micro, mini), PCI, AGP, COM, LPT, PS/2, SATA, FireWire, etc.

I/O facilities (306) are also selected from a known range of different devices, for example, a keyboard, touchpad, touchscreen display, monitor, mouse, etc. and can be connected if needed while working individually with a specific server.

Data transfer devices (307) are selected from devices designed to implement the communication process between various devices through wired and/or wireless communication, in particular, such devices can be: Ethernet module, GigabitEthernet module, 10-GigabitEthernet module, 40-GigabitEthernet module, 100-GigabitEthernet module, Infigdand SDR 1X module, InfiniBand DDR 1X module, InfiniBand QDR 1X module, InfiniBand SDR 4X module, InfiniBand DDR 4X module, InfiniBand QDR 4X module, InfiniBand FDR 4X module, InfiniBand EDR 4X module, InfiniBand HDR 4X module, IntelOmni-Path module etc.

Components of the system (300) are interconnected by a common data bus (304).

The large number of servers in clusters and the large calculating power of modern BigData clusters should not cause unjustified illusions. Although they may be a technological platform for the implementation of asset management strategic systems, this will require their limits at the level of limitations due to the current level of technology development. Existing cluster management systems support collaboration of up to a million virtual machines located in different data reduction centers [40]. This roughly corresponds to 100,000 real servers. While using the operating mode, when physical severs are controlled instead of virtual (baremetal), the maximum total number of physical servers in a cluster can be increased to one million.

Existing practical experience shows that modern simulation systems can simultaneously simulate the failure flows for several thousand pieces of equipments on one server. With the maximum server configuration, it can model failure flows for 10-15 thousand objects.

The whole complex of applications has very high total requirements for cluster resources:

Search for local optima of bilinear and trilinear tasks of supply chain optimization, it is advisable to organize in parallel on hundreds of servers in order to find the global optimum more quickly. The specific number of servers required for parallel search of one global optimum depends on the complexity of the supply chain structure. As part of the analysis of one long-term development variant, 20-30 such tasks need to be solved, it is advisable to solve them in parallel or at least partially in parallel.

Large enterprises may have millions or tens of millions of assets whose condition must be forecasted. Even with relatively small resource requirements on the part of simulation systems, it may take a thousand or more servers at the same time, if trying to model all objects in one step without spreading this process over time. The simulation system will go through one year interval after another in order to consistently trace changes in the assets state.

In the process of forming of an optimal work plan and resource allocation for the next period (quarter, month), it is necessary to analyze a large number of long-term development variations. It is advisable to parallelize this process.

Mentioned rough estimates of resource requirements from the individual components of the strategic asset management system show that when implementing each of the system units, it will be very economical to use the resources of a single large BigData cluster.

The proposed strategic asset management algorithm (method) allows building a closed loop of asset management on a time interval comparable to the life cycle value of the long-running assets that make up the company's fixed capital. The absence of such a control loop is clearly felt in the functionality of modern EAM systems and corporate control systems at whole.

### Information Resources

1. Mabert V. A. The early road to material requirements planning//Journal of Operations Management, Vol. 25. Issue 2. March 2007. P. 346-356. URL: http://opac.vimaru.edu.vn/edata/E-Journal/2007/Journal_of_Operations_Management/J.%20Operations,%20Vol.%2025,% 20Issue.%202,%20A.%2011.pdf
2. Landvater D. V., Gray C. D. MRP II Standard System: A handbook for Manufacturing Software Survival. Essex Junction, Vt.: Oliver Wight Publications, 1989. xxiv, 349 p.
3. APICS Dictionary. 13th edition, Ed.: John H. Blackstone Jr., Ph.D., CFPIM. Jonah's Jonah, APICS, 2011. 164 p.
4. Asefeso A. Lean Six Sigma (Cost Reduction Strategies). Swindon: AA Global Sourcing Ltd, 2012. 166 p.
5. Just-in-time manufacturing. Seen2. URL: http://www.seen2.com/learn?s=Just_In_Time_(business)http://www.seen2.com/learn?s=Just_In_Time_(business)http://www.seen2.com/learn?s=Just_In_Time_(business)http: //www.seen2.com/learn?s=Just_In_Time_(business)http://www.seen2.com/learn?s=Jus t_In_Time_(business)http://www.seen2.com/learn?s=Just_In_Time_(business)http://ww w.seen2.com/learn?s=Just_In_Time_(business)http://www.seen2.com/learn?s=Just_In_Time_(business)
6. Theory of constraints (TOC). Six Sigma Study Guide, Apr. 17, 2014. URL: http://sixsigmastudyguide.com/theory-of-constraints/( [symbol] [symbol] [symbol] [symbol] LinkedIn)
7. Mather D. The Total EAM Vision Strategic Advantages in Asset Management.Technologyevaluation. URL: https://www.technologyevaluation.com/research/article/The-Total-EAM-Vision-Strategic-Advantages-in-Asset-Management.html
8. Magic Quadrant for Energy and Utilities Enterprise Asset Management Software. Gartner, 15 Sep. 2015, ID:G00270950, Analyst: Eriksen L. URL: https://www.gartner.com/doc/reprints?id=1-2MTYCSC&ct=150910&st=sb
9. Prabhakar D. P., Raj J. V. P. CBM, TPM, RCM and A-RCM-A Qualitative Comparison of Maintenance Management Strategies//IJMBS Vol. 4, Issue 3, July-September 2014, P. 49-56. URL: http://www.ijmbs.com/Vol4.3/8-Deepak-Prabhakar-P.pdf
10. PPM (project and portfolio management). TechTarget. URL: http://searchcio.techtarget.com/definition/PPM-project-and-portfolio-management
11. Project Portfolio Management: A View from the Management Trenches. The Enterprise Portfolio Management Council: Stratton M. J; Wybraniec M.; Tekumalla S.; Stabler M.; Retna S.; Miller D. D.; Gosnear M.; Jenner S.; Mee M.; Menke M. M. Hoboken, N. J., John Wiley & Sons, Inc., 2009. 252 p. ISBN 978-0470505366
12. The Forrester Wave™: Portfolio Management For The Tech Management Agenda, Q1 2015/Visitacion M., Barnett G. Forrester, Mar. 18, 2015, Updated: Apr. 28, 2015. URL: http://go.planview.com/rs/587-QLI-337/images/The_Forrester_Wave Port.pdf?mkt_tok=eyJpIjoiTVRWa1pXSXdNelZsTj AMSIsInQi0iJoTm9kZUdOTjY3YmY1Z0d6TmJ4T2V1OWtnV1cObnE4Nkc4Y1psakdqR WhxTE4zR21WcWNcLO1tVD15cUUxMO5ENOsxb2E4dzd6aUZkOEt5VW5Od2tqYTQ2O WFJcm03YnINRnIhRkQ0XC9WNFIjPSJ9
13. Magic Quadrant for Advanced Analytics Platforms. Gartner, 9 Feb. 2016, ID:G00275788, Analysts: Kart L., Herschel G., Linden A., Hare J. URL: https://www.gartner.com/doc/reprints?id=1-2YEVU8U&ct=160210&st=sb
14. Prognoz Platform 8. Online documentation. Prognoz. URL: http://help.prognoz.com/en/help.htm # mergedProjects/Intro/architecture/inf_delivery_ana lysis.htm # Modelling
15. [symbol] A. A. [symbol] [symbol] [symbol] [symbol] [symbol] [symbol] B [symbol] [symbol] (2020-2030 ΓΓ.)// [symbol] [symbol] [symbol] [symbol] 2016, No212, C. 69-78
16. Internal Rate Of Return IRR. Investopedia. URL: http://www.investopedia.com/terms/i/irr.asp
17. Chase C. W., Jr. Demand-Driven Forecasting: A Structured Approach to Forecasting. Second Edition. John Wiley & Sons, Inc., Hoboken, N.J., 2013. 384 P.
18. Service Parts Management: Demand Forecasting and Inventory Control/Editors: Altay N., Litteral L. A. London: Springer-Verlag, 2011. 327 p.
19. Hong W-C. Intelligent Energy Demand Forecasting. London: Springer-Verlag, 2013. 202 p.
20. Russell S. J., Norvig P. Artificial Intelligence: A Modern Approach (Third Ed.). Upper Saddle River, New Jersey: Prentice Hall, Inc. A Pearson Education Company, 2010, pp. 830-859.
21. Gen M., Cheng R. Genetic Algorithms and Engineering Design. NY: John Wiley & Sons, Inc., 1997. 427 p.
22. Affenzeller M., Winkler S., Wagner S., Beham A. Genetic Algorithms and Genetic Programming: Modern Concepts and Practical Applications. Boca Raton, Fla.: Chapman and Hall/CRC Taylor & Francis Group, 2009. 376 p.
23. Luque G., Alba E. Parallel Genetic Algorithms: Theory and Real World Applications. Springer-Verlag Berlin Heidelberg, 2011. 172 p.
24. Goetschalckx M. Supply Chain Engineering. Springer New York Dordrecht Heidelberg London, 2011. 682 p.
25. [symbol] A. A., [symbol] A. B., [symbol] C., [symbol] B. [symbol] [symbol] [symbol] APS [symbol] [symbol] [symbol] [symbol] // [symbol] [symbol] [symbol] [symbol] 2016. T. 29, No 4, C. 5-14. URL: http://www.swsys.ru/files/2016-4/_5-14.pdf
26. [symbol] [symbol] [symbol] [symbol] [symbol] [symbol] [symbol] [symbol] [symbol] [symbol] Ha [symbol] [symbol] [symbol] [symbol] [symbol] [symbol] TexH HayK. CeBepo- [symbol] [symbol] Y_{H-T}, [symbol] , 2001, 390 c.
27. [symbol] [symbol] [symbol] [symbol] [symbol] . URL: http://www.vniir.ru/production/cat/cat/abs-vniir-analiz.pdf
28. AO « [symbol] [symbol] [symbol] [symbol] [symbol] ». URL: http://sk.kz/?lang=ru
29. Stamatis D. H. Failure Mode and Effect Analysis: FMEA from Theory to Execution. Second Edition, Revised and Expanded. Milwaukee, Wis.: American Society for Quality, Quality Press, 2003. 463 p. +223 p. on CD
30. Carlson C. S. Effective FMEAs: Achieving Safe, Reliable, and Economical Products and Processes Using Failure Mode and Effects Analysis. Hoboken, N.J.: John Wiley & Sons, Inc., 2012. 459 p.
31. Liu H.-C. FMEA Using Uncertainty Theories and MCDM Methods. Springer Science+Business Media Singapore, 2016. 218 p.
32. [symbol] [symbol] [symbol] [symbol] [symbol] [symbol] [symbol] [symbol] [symbol] [symbol] // [symbol] [symbol] 2009 No1 c. 30-37
33. Wenzler I. Development of an asset management strategy for a network utility company: Lessons from a dynamic business simulation approach//Simulation & Gaming, March 2005, vol. 36, No 1, P.75-90. URL: http://citeseerx.ist.psu.edu/viewdoc/download?doi=10.1.1.117.985&rep=rep1&type=pdf
34. SAP Leonardo: Innovation Portfolio. URL: https://www.sap.com/documents/2016/12/84e838d6-9d7c-0010-82c7-eda71af511fa.html
35. Walder J.-B. CIM: Principles of Computer Integrated Manufacturing. John Wiley & Sons Ltd., 1992, 206 p.
36. Magic Quadrant for Master Data Management Solutions. Gartner, 19 Jan. 2017, ID: G00305598. Analysts: O'Kane B., Palanca T., Moran M. P. URL: https://www.gartner.com/doc/reprints?id=1-3RH206C&ct=170120&st=sb
37. The Forrester Wave™: Master Data Management, Q1 2016/Goetz M. Forrester, Mar. 16, 2016, 18 p.
38. [symbol] A. A. [symbol] B. [symbol] . [symbol] [symbol] [symbol] [symbol] [symbol] [symbol] [symbol] MacTep - [symbol] [symbol] [symbol] // [symbol] [symbol] [symbol] [symbol] . 2017. T. 30, No 1, C. 51-60. URL: http://www.swsys.ru/files/2017-1/_51-60.pdf
39. [symbol] A. A., [symbol] C. [symbol] [symbol] BigData Ha [symbol] [symbol] [symbol] [symbol] C [symbol] // [symbol] [symbol] . HayKa [symbol] [symbol] [symbol] [symbol] H [symbol] [symbol] 2015. No 03. C. 207-240. URL: http://technomag.bmstu.ru/doc/761354.html
40. Building Multi-Site & Ultra-Large Scale Cloud with Openstack Cascading/Huawei//Mobile World Congress 2015, Barcelona, 2-5 Mar. 2015. URL: http://www.huawei.com/minisite/mwc2015/en/articles/building-multi-Site-ultra-large-scale-cloud-with-openstack-cascading.html

1. A computer-implemented method for allocation planning of resources of an enterprise for acquisition, construction and commissioning of new assets, as well as modernization, repair, maintenance and decommissioning of existing assets, which comprises stages in which:
input of an initial data containing the following information is performed:
about the existing tangible assets of the enterprise, which include buildings, structures, land, equipment, construction objects and other tangible objects, as well as existing intangible assets that include software, databases, patents, licenses, trademarks and other intangible objects, and wherein the mentioned data are entered using a Master Data Management System of assets, which provides creation and support of several different interrelated representations of master data of the same assets fleet at the same time;
about possible projects, works and activities for purchase, construction and commissioning of new assets, modernization, repair, maintenance and decommissioning of existing assets, and wherein for data entering a Portfolio Management System for projects, works and activities is used, providing formation, maintenance and use of multiple portfolios of projects, works and activities for maintenance and repairs, restrictions compliance, construction, purchase, commissioning, reconstructions of assets and decommissioning supporting connections between various elements of portfolios and a possibility of ranking the elements inside portfolios;
about possible scenarios of economic development, restrictions on the enterprise's activities, established in an accepted development strategy, about a size of a discount rate used to estimate the performance of the enterprise, and wherein to input the mentioned data, a System for maintaining of economic development scenarios is used, providing formation, maintenance and use of scenario network of development of a company or organization for a period of 20-30 years;
on the basis of economic development scenarios, using the System for maintaining of economic development scenarios, a scenario network is built with possible transitions between scenarios at the end of each year, wherein each transition should be characterized by a predicted probability of this transition;
in the built scenario network, using a Basic Management Module implementing a long-term asset management algorithm, a scenario corridor with relatively high probabilities that has a fixed width is selected;
for each annual period within a selected scenarios corridor using one or several modules for demand and restrictions forecasting, a demand for products and values of restrictions, that will be valid for this annual period, is predicted, while paralleled used modules for demand and restrictions forecasting can be used to predict the following approaches: time series analysis, causal-investigatory analysis, artificial intelligence methods, evolutionary methods, and other mathematical models and methods, including those oriented on different product categories—niche products, new products, growing brands and products which are taken out of the market, as well as on different types of products —spare parts, electricity, services and transport services;
on the basis of the constructed scenario network within the framework of the selected corridor, using a module for chaining formation of annual periods in a search mode, chains of annual periods are formed covering the entire planning period, total probabilities for each chain of annual periods are calculated and chains with low probabilities are excluded from further consideration;
for each selected chain of annual periods, using a module for generating of long-term development optimums by genetic algorithms, search for asset filling optimums allowing to satisfy the forecasted demand, completion dates for projects and activities are determined, providing construction, purchase and commission of new assets, as well as modernization or decommissioning of existing assets, and wherein each chain of annual periods with linked assets and projects is a further analyzed long-term development variation;
for each annual interval of each long-term development variation, using one or several Systems for optimizing of internal supply chains based on linear, bilinear, trilinear and special mathematical models, optimal plans for internal supply chains are constructed;
for each long-term development variation using a module for maintenance and repair activities planning on the basis of a search of possible maintenance and repair options, starting with the most economical and less resource-intensive variants,
for each variant of long-term development, with a help of a Planning Module of activities and restrictions measures, on the basis of a search of possible variants, starting with the most economical, requiring fewer resources, indispensable projects and activities on compliance with the established restrictions are identified;
an estimate is made of the feasibility of yearly optimal plans of internal supply chains and an estimate of compliance with the established restrictions using one or several Complexes of asset states modeling to estimate a feasibility of plans using one of the following mathematical models and methods: methods of stochastic programming, methods of the fuzzy-set theory and multi-criteria decision-making, methods of artificial intelligence and machine learning, methods of simulation modeling;
among the formed and modeled long-term development variations using the Basic Management Module implementing the long-term asset management algorithm, long-term development variations are determined and excluded, for which the calculated optimal plans of internal supply chains and restrictions compliance are not provided;
projects changing the composition of assets fleet are planned using the Project Planning Module changing the composition of assets fleet, which distribute the remaining production and financial resources for the implementation of projects for purchase, construction and commissioning of new assets, as well as reconstruction and decommissioning of existing assets;
among the formed and modeled long-term development variations using the Basic Management Module, which implementing the long-term asset management algorithm, long-term development variations are determined and excluded, which have the lack of financial or other resources to carry out all planned projects for commissioning of new assets, reconstruction and decommissioning of existing assets;
for a filtered set of long-term development variations, using the Basic Management Module, implementing the long-term asset management algorithm, the total probabilities of the presence of individual projects, work and activities are calculated;
the total probabilities of individual projects, work and activities are used by the Basic Management Module, implementing the long-term asset management algorithm, to increase the sustainability of the most likely long-term development variations by including the most likely projects, work and activities, in conditions of the limited decrease of the achievable maximum of discounted profit for the entire development period;
from the most likely long-term development variations using the Basic Management Module implementing the long-term asset management algorithm, the one with the higher sum of probabilities of projects (work, activities) included in it, is selected, and with equal sum of probabilities, the one providing the achievement of a greater total discounted profit for all periods;
for the selected long-term development variation, using the Basic Management Module, implementing the long-term asset management algorithm, budgets of work and activities project portfolios are calculated for the nearest established period of time, and it is used to plan work for this period;
using the Portfolio Management System for projects, work and activities, the Master data management system of assets and the Economic development scenario maintenance system, the initial data are updated, and all steps of the method are repeated to select a work plan for a next fixed period.

2. The method according to claim 1, characterized by the fact that each of the variants used for generating of long-term development of predefined scenarios of economic development is characterized by a given probability, and besides the scenarios contain forecasts of demand, technological capabilities, financial conditions, various economic, social and natural factors, resource availability and other indicators presented in dynamics and regional detailing.

3. The method according to claim 1, characterized by the fact that the information about assets includes information about the types of these assets, their accessory, functional connections and characteristics.

4. The method according to claim 3, characterized by the fact that the characteristics of the assets in the case of simulation models use to estimate the feasibility of the plans, along with other data, determine:
all types of failures occurring in this type of assets;
statistical distribution of the occurrence of each type of failure;
consequences of the occurrence of each type of failure, both in terms of indicators and asset performance, as well as in terms of events and indicators regulated by restrictions;
all types of repair and maintenance work for this type of asset;
impact of each type of repair and maintenance work on the statistics of the occurrence of each type of failure.

5. The method according to claim 1, characterized by the fact that the list of assets includes natural resources available to the enterprise, which it can use in its activities.

6. The method according to claim 1, characterized by the fact that the restrictions of various types, reflecting the requirements of customers, the external environment, regulators, owners and management of the company: financial, technical, market, environmental and others are established on the basis of the adopted strategy of the company and used in the searching process of long-term development variations.

7. The method according to claim 1, characterized by the fact that everything connected with the development and support of assets, projects, work and activities, including at least:
investment projects providing the creation and purchase of new assets, their reconstruction or decommissioning, and/or
innovative projects providing used technology and asset performance improvement, and/or
activities and work for maintenance and repair of assets,
structured into several groups of portfolios, each of which contains the number of portfolios equal to the number of activities of the company.

8. The method according to claim 7, characterized by the fact that in the first group of portfolios, each portfolio connected with a specific type of activity contains activities and work related to the maintenance and operability assurance of the assets involved in this type of activity.

9. The method according to claim 7, characterized by the fact that in the second group of portfolios, each portfolio connected with a specific type of activity contains all investment and innovation projects and activities of assets involved in this type of activity, affecting the composition and characteristics of the assets fleet.

10. The method according to claim 7, characterized by the fact that in the third and subsequent groups of portfolios, each portfolio connected with a specific type of activity contains all investment and innovation projects and activities of assets involved in this type of activity, providing a change in the indicators values taken into account in one of the limitations.

11. The method according to claim 10, characterized by the fact that for each indicator established by the restrictions, own group of portfolios is formed.

12. The method according to claim 7, characterized by the fact that between elements within individual portfolios and between elements of different portfolios, dependencies on execution can be established, determining that a specific project/activity/work cannot be fulfilled, until all projects/activities/work on which this element is dependent, are performed.

13. The method according to claim 7, characterized by the fact that all projects included in the portfolios, work and activities are assigned sets of characteristics that are different for each group of portfolios.

14. The method according to claim 13, characterized by the fact that all elements of the portfolios have characteristics determining duration of execution, necessary costs, and other resources—quantity and qualification of personnel, necessary technical tools and materials.

15. The method according to claim 8, characterized by the fact that in the portfolios of the first group related to the maintenance and operability assurance of assets, each element of the portfolio has the following characteristics:
a set of values by which the occurrence probability of certain types of failures of specific types of assets after the present work is reduced;
the duration of the temporary suspension of assets use during maintenance.

16. The method according to claim 9, characterized by the fact that in the portfolios of the second group, associated with changes in the composition of the assets fleet and the characteristics of individual assets, all projects and activities must be characterized by indicators of potential revenues.

17. The method according to claim 10, characterized by the fact in the portfolios of the third and subsequent groups associated with changes in indicators taken into account in one of the restrictions, all elements must be characterized by estimates of the impact on the indicator considered in the restriction.

18. The method according to claim 13, characterized by the fact that all portfolios elements are ranked by execution priority based on their characteristics.

19. A method according to claim 12, characterized by the fact that the ranking of the elements of portfolios and the existing dependencies between portfolio elements uniquely determine the composition of the performed projects and activities depending on the budgets allocated to each portfolio.

20. The method according to claim 1, characterized by the fact that during planning of internal supply chains for each annual interval, according to the already known composition of production and technical complexes in this interval and well-known demand estimate, an optimal purchase, production and sales plan is formed, in which all necessary movements of raw materials, semi-finished and finished products are reflected.

21. The method according to claim 20, characterized by the fact that for optimizing of the internal supply chains, linear, bilinear, trilinear or special mathematical models are used, as well as combinations of all the types of the mentioned models.

22. The method according to claim 21, characterized by the fact that bilinear mathematical models are used in one of the following cases to optimize internal supply chains:
subsidiaries of the enterprise for which resources are distributed, are located in different states or in different economic zones that differ in taxation;
the company operates in one of the industries related to continuous production, when from the same raw materials, using same facilities and at different processing modes, different quantities of semi-finished products or final products can be obtained.

23. The method according to claim 21, characterized by the fact that to optimize internal supply chains, trilinear mathematical models are applied when both conditions are met:
the enterprise's subsidiaries for which resources are distributed, are located in different states or in different economic zones that differ in taxation;
the company operates in one of the industries related to continuous production, when from the same raw materials, using same facilities and at different processing modes, different quantities of semi-finished products or final products can be obtained.

24. The method according to claim 21, characterized by the fact that to optimize the internal supply chains, special models are used when material entities are transported, not having a real form (electricity, information) or non-traditional means of material entities transporting that have a real form are used.

25. The method according to claim 21, characterized by the fact that to optimize the internal supply chains, combinations of various models working in parallel are used if:
the company's activities are diversified, and certain areas of activity are weakly intersected;
due to the specifics of supply chains in different areas of the company, models of different types are required to be applied.

26. The method according to claim 21, characterized by the fact that the applied optimization models for supply chains take into account the specifics of the company's logistics and production processes and are constructed in accordance with one of the following principles:
It is necessary to satisfy all customers' needs in all market areas.
The desired optimal production and transportation plan does not have to satisfy all customer requests, it is necessary to maximize the use of existing assets.
It is necessary to ensure the mandatory satisfaction of the needs of only individual customers with whom long-term special contracts have been signed, guaranteeing full satisfaction of orders for the supply of all or specific types of products.

27. The method according to claim 1, characterized by the fact that to estimate the feasibility of the generated optimal supply plans and comply with the established restrictions, can be used simulation models, machine learning models, special models of natural resources (hydrodynamic models, geological models, etc.), as well as combinations of these models.

28. The method according to claim 27, characterized by the fact that in the case of using of a combination of different models to estimate the feasibility of the generated optimal supply plans and comply with the established restrictions, each asset is modeled using a model of only one type. Different types of models can only be used for different assets.

29. The method of claim 27, characterized by the fact that in the case of using of simulation models, to estimate, on part of assets, realizability of generated optimal supply plans and compliance with established restrictions, a complex of such models for this part of activities is used, each of them imitates a separate asset's work.

30. The method according to claim 29, characterized by the fact that during the entire annual period for which the supply chain was planned, the impact of failure flows on the components of the production and processing complex is modeled, as well as performance of maintenance and repair, innovation and investment projects changing the states of existing assets and leading to the occurrence of new assets.

31. The method according to claim 29, characterized by the fact that after repeated run of simulation models for each production and technological complex involved in the planned supply chain, a statistically reliable estimates are formed:
ability of the complex to complete the scope of work, determined by the optimus of supply chains;
indicators regulated by restrictions.

32. The method according to claim 29, characterized by the fact that while simulating modeling of the assets states within an annual period, assets state is fixed at the end of the year and the modeling of the next annual period within one long-term development variation is performed starting from the fixed asset state.

33. The method according to claim 1, characterized by the fact that the planning process and implementing complex of applications operate continuously, implementing sliding planning. After the completion of one full cycle of searches, the optimal action plan and budget allocation for the nearest period (quarter or month) is determined. The found plan begins to be used in the company's activities, the budget for the nearest period is distributed in accordance with the found optimal distribution, and the process returns to the beginning, in order to begin long-term planning again and form an optimal action plan for the next period.

34. The method according to claim 33, characterized by the fact that after the next year ends and the initial period of annual planning shifts, the final period also shifts, providing a constant value of the used prediction time interval at asset management.

35. The method according to claim 33, characterized by the fact that in the first step of the algorithm, data of assets, economic development scenarios and portfolios of projects/work/activities are updated.

36. The method according to claim 33, characterized by the fact that in the second step a forecast of demand and restrictions is made.

37. The method according to claim 33, characterized by the fact that after the second step, the search of chains of annual periods begins, while the analysis of each long-term development variation begins with the current state of the assets.

38. The method according to claim 37, characterized by the fact that the first verification of the feasibility of the formed variant of long-term development is carried out after calculating the optimal annual plans of supply chains.

39. The method according to claim 38, characterized by the fact that when during the verification there are situations that some mandatory product deliveries cannot be fulfilled, the production facilities stand idle due to the lack of the possibility of raw materials supplying, etc., then from the supply chains are excluded unreliable (based on characteristics, formed as a result of verification) elements or additional elements are included in the supply chain, and they are rescheduled.

40. The method according to claim 39, characterized in that when rescheduling is not possible due to the lack of reserves in the supply chain, a forced blocking the least significant project requiring critical resources and returning to the stage of generating a new optimal variant of long-term development.

41. The method according to claim 37, characterized by the fact that when the long-term development variations pass the first reasonability check (all suppliers, factories and distribution centers are able to fulfill the calculated optimal plans), maintenance and repair work and activities are planned, as well as projects and activities for upholding of restrictions.

42. The method according to claim 41, characterized by the fact that the planning of works and activities for maintenance and repairs begins with the most economical options requiring fewer resources.

43. The method according to claim 41, characterized by the fact that, when at some annual period there are no assets capable to perform the planned annual program, a transition is made to the re-planning of works and maintenance and repair activities with the allocation of more resources for these purposes.

44. The method according to claim 41, characterized by the fact that, when at any annual period the restrictions are violated, a transition is made to the planning of projects and activities for upholding of restrictions with the allocation of more resources.

45. The method according to claim 43, characterized by the fact that in cases when the estimate of planning results is carried out only with the help of a set of simulation models and special models of natural resources, due to the high requirements of such verification to computing power, the planning results are estimated together both in terms of upholding of restrictions, and in terms of the feasibility of optimal supply chains.

46. The method according to claim 41, characterized by the fact that when a further increase in resources for maintenance and repairs becomes impossible, a transition to the re-formation of annual supply chains is made.

47. The method according to claim 41, characterized by the fact that a transition to the re-formation of annual supply chains is also performed, when further increase of resources for projects and activities for upholding of restrictions is impossible.

48. The method of claim 46, characterized by the fact that when the re-formation of annual supply chains does not allow to reduce resource requirements, the least significant project consuming critical resources is blocked, and a transition to the generation of a new long-term development takes place.

49. The method according to claim 37, characterized by the fact that after determining of the minimum required amount of resources for maintenance and repairs, as well as upholding of restrictions, all remaining resources are allocated for the implementation of projects for purchase, construction and commissioning of new assets, as well as reconstruction and decommissioning of existing assets.

50. The method according to claim 37, characterized by the fact that after the allocation of resources, an estimate is made of whether there are enough resources (including financial) in order to realize all the projects necessary for the occurrence of the assets required for subsequent annual periods.

51. The method of claim 37, characterized by the fact that, when the assets necessary for the subsequent periods do not appear, an attempt to redistribute resources to the projects is made.

52. The method according to claim 37, characterized by the fact that in case of exhaustion of the possibilities for the redistribution of resources between projects, a transition to the generation of a new variant of long-term development occurs.

53. The method according to claim 37, characterized by the fact that when the long-term development variant successfully passes all the verifications, then it is remembered.

54. The method according to claim 33, characterized by the fact that, on the basis of the probabilities of the stored long-term development variants, the total own probabilities of individual work projects and activities presenting at least in one long-term development scenario are calculated.

55. The method of claim 33, characterized by the fact that the search of stored long-term development variants having the same maximum probability of implementation takes place, and each of them is examined for the possibility of including projects, works and activities not included in it and having higher probabilities than projects, work and activities included in it, without significant loss of the value of the target function.

56. The method according to claim 55, characterized by the fact that, starting with an element having the maximum own value of probability, projects, work and activities are added one by one as mandatory while re-generating the most likely variants of long-term development using a genetic algorithm.

57. The method according to claim 56, characterized by the fact that after each addition, the obtained variant is supplemented with projects, work and activities, as well as its estimate.

58. The method according to claim 56, characterized by the fact that the process continues until the resulting deviation of the value of the target function does not exceed a certain established threshold value. Each time, the last variant is saved, satisfying all the conditions, including the restriction on the deviation of the target function.

59. The method according to claim 55, characterized by the fact that after completion of the processing of one long-term development variant having the maximum probability, a comparison with the processing results of other such variants and the selection of one that has a higher sum of its own probabilities of the projects included in it (work, activities) is made. And with equal sums of their own probabilities—one that ensures the achievement of greater total discounted profit for all periods.

60. The method according to claim 59, characterized by the fact that since the long-term development variation may include a different number of elements, not just the variant with the maximum sum of the own probabilities of all included projects is chosen, but the option with the maximum specific amount, i.e. the largest sum of the own probabilities of all included projects (work, activities) divided by the number of included projects (work, activities).

61. The method according to claim 33, characterized by the fact that for the selected best long-term development variant, budgets for portfolios of projects, work and activities are calculated for the nearest period.

62. The method according to claim 1, characterized by the fact that the software complex should preferably be performed on BigData clusters consisting of a large number of servers, each of which performs processing of a certain part of the data placed in its own operative or external memory.

63. A mechanism for planning the allocation of resources of an enterprise for purchase, construction and commissioning of new assets, as well as modernization, repair, maintenance and decommissioning of existing assets, containing at least one server, including:
at least one processor;
and
at least one memory containing machine-readable instructions, which, when executed, cause at least one processor to implement the method according to claim 1.
